(19) United States
(12) Patent Application Publication
(10) Pub. No.: US 2020/0026611 A1
(43) Pub. Date: Jan. 23, 2020

(54) UPDATING A SNAPSHOT OF A FULLY ALLOCATED STORAGE SEGMENT BASED UPON DATA THEREWITHIN

(71) Applicant: International Business Machines Corporation, Armonk, NY (US)

(72) Inventors: Shekhar Amlekar, Pune (IN); Sasikanth Eda, Vijayawada (IN); Karthik Iyer, Bangalore (IN); Sandeep R. Patil, Pune (IN); Sachin C. Punadikar, Pune (IN)

(21) Appl. No.: 16/223,509

(22) Filed: Dec. 18, 2018

Related U.S. Application Data
(63) Continuation of application No. 16/041,940, filed on Jul. 23, 2018, now abandoned.

(51) Int. Cl. G06F 11/14; G06F 16/11

(52) U.S. Cl. CPC G06F 11/1451; G06F 2201/84; G06F 16/128

(57) ABSTRACT

A computer includes a storage segment fully allocated to an application. The storage segment initially includes a repeating initialization data pattern there within. After the application begins its workload, the application writes application data to a portion of the storage segment. A snapshot application takes a snapshot of the storage segment. After the snapshot, the application generates a post-snapshot-write to the storage segment. The snapshot application determines whether the post-snapshot-write modifies application data or modifies the repeating initialization data pattern. If the post-snapshot-write modifies the repeating initialization data pattern within the storage segment, the snapshot application blocks the repeating initialization data pattern from being copied and moved which resultantly blocks modification of the snapshot. If the post-snapshot-write modifies application data, the snapshot application copies and moves the application data to a destination storage location which resultantly modifies the snapshot to identify the destination storage location of the moved application data.

### FIELD OF THE INVENTION

Embodiments of the invention generally relate to data handling systems and more particularly to updating a snapshot of a fully allocated storage segment based upon the data within the fully allocated storage segment.

### DESCRIPTION OF THE RELATED ART

A snapshot of a dataset contains the state of the dataset at a respective point in time when the snapshot is created. A snapshot application can create a snapshot without any substantial disruption to concurrent read-write access to or from the dataset. Typically, the dataset is data contained within a storage segment, such as a logical volume, a file system, or a file, and the snapshot application is adapted to make a snapshot of the dataset within the storage segment. Snapshots have been used for a variety of data processing and storage management functions such as storage backup, transaction processing, and software debugging. In general, a snapshot application must keep a record of the dataset that has been changed since the point in time when the snapshot was created. Generally, a record is kept of whether data within each portion of the storage segment that stores the dataset have been modified since the time of the snapshot.

Some applications, like a database application, typically allocate or have allocated one or more storage segments to which solely the application can utilize (i.e. write application data to, and the like). Typically, there are two ways in which these allocated storage segments are created. In a first approach, a sparse storage segment less than the size of the entire storage segment is allocated to the application. This approach is known in the art as thin provisioning. In the other approach, one or more entire storage segments are allocated to the application and contain an initialization dataset pattern there within, respectively. These fully allocated storage segments ensure that the entire storage segments are available to the application to utilize.

Sometime after the application has written application data to the fully allocated storage segment, a snapshot of that fully allocated storage segment is taken. Just prior to the time of the snapshot, the application may be actively utilizing this storage segment. Typically, however, such active transactions to or from the storage segment are paused, or the like, so the time of the snapshot of the storage segment may be consistent with other snapshots of other storage segments. Once the snapshot of the storage segment(s) is taken, the application is notified that it may resume utilizing the storage segment(s).

After the snapshot, the snapshot application tracks the storage segment and creates the record of which data within the storage segment has been modified since the time of the snapshot. Typically, the snapshot application is not aware that the application is writing new application data to the storage segment in place of the existing initialization pattern. Therefore, the snapshot application typically treats the initialization pattern as existing and important data and tracks changes to such data after the snapshot of the associated storage segment is taken.

### SUMMARY

In an embodiment of the present invention, a method of managing a snapshot of a fully allocated storage segment based upon data within the fully allocated storage segment is presented. The method includes allocating a storage segment consisting of a repeating initialization data pattern to a first application and storing metadata associated with the storage segment that specifies the repeating initialization data pattern. The method further includes writing, with the first application, application data to a portion of the storage segment and taking, with a snapshot application, a snapshot of the storage segment. The method further includes generating, with the first application, a post-snapshot-write to the storage segment and determining, with the snapshot application, whether the post-snapshot-write modifies application data within the storage segment or modifies the repeating initialization data pattern within the storage segment. The method further includes, if the post-snapshot-write modifies the repeating initialization data pattern within the storage segment, blocking, with the snapshot application, the repeating initialization data pattern from being copied and moved, thereby blocking modification of the snapshot of the storage segment. The method further includes writing, with the first application, the post-snapshot-write to the storage segment thereby modifying the repeating initialization data pattern within the storage segment.

In yet another embodiment, a computer program product for managing a snapshot of a fully allocated storage segment based upon data within the fully allocated storage segment is presented. The computer program product includes a computer readable storage medium having program instructions embodied therewith, the program instructions are readable to cause a processor to allocate a storage segment consisting of a repeating initialization data pattern to a first application and store metadata associated with the storage segment that specifies the repeating initialization data pattern. The program instructions are further readable to cause the processor to write application data to a portion of the storage segment and to take a snapshot of the storage segment. The program instructions are further readable to cause the processor to generate a post-snapshot-write to the storage segment and to determine whether the post-snapshot-write modifies application data within the storage segment or modifies the repeating initialization data pattern within the storage segment. The program instructions are further readable to cause the processor to, if the post-snapshot-write modifies the repeating initialization data pattern within the storage segment, block the repeating initialization data pattern from being copied and moved, and resultantly block modification of the snapshot of the storage segment. The program instructions are further readable to cause the processor to write the post-snapshot-write to the storage segment thereby modifying the repeating initialization data pattern within the storage segment.

In yet another embodiment, a computer comprising a processor and a memory is presented. The memory has program instructions embodied therewith which are readable to cause the processor to allocate a storage segment consisting of a repeating initialization data pattern to a first application and to store metadata associated with the storage segment that specifies the repeating initialization data pattern. The program instructions are further readable to cause the processor to write application data to a portion of the storage segment and to take a snapshot of the storage segment. The program instructions are further readable to cause the processor to generate a post-snapshot-write to the storage segment and to determine whether the post-snapshot-write modifies application data within the storage segment or modifies the repeating initialization data pattern within the storage segment. The program instructions are further readable to cause the processor to, if the post-snapshot-write modifies the repeating initialization data pattern within the storage segment, block the repeating initialization data pattern from being copied and moved, and resultantly block modification of the snapshot of the storage segment. The program instructions are further readable to cause the processor to write the post-snapshot-write to the storage segment thereby modifying the repeating initialization data pattern within the storage segment.

These and other embodiments, features, aspects, and advantages will become better understood with reference to the following description, appended claims, and accompanying drawings.

### BRIEF DESCRIPTION OF THE DRAWINGS

FIG. 1 illustrates a high-level block diagram of an exemplary data handling system, such as a computer, for implementing various embodiments of the invention.

FIG. 2 illustrates an exemplary fully allocated storage segment, according to various embodiments of the present invention.

FIG. 3 illustrates an exemplary fully allocated storage segment prior to a snapshot being taken thereof, according to various embodiments of the present invention.

FIG. 4 illustrates an exemplary snapshot of the fully allocated storage segment, according to various embodiments of the present invention.

FIG. 5 illustrates an exemplary fully allocated storage segment after the snapshot, according to various embodiments of the present invention.

FIG. 6 illustrates the snapshot of the fully allocated storage segment when application data and initialization pattern data has been modified after the time of the snapshot, according to various embodiments of the present invention.

FIG. 7 illustrates an exemplary method of updating a snapshot of a fully allocated storage segment based upon data within the fully allocated storage segment, according to various embodiments of the present invention.

FIG. 8 illustrates an exemplary method of restoring the fully allocated storage segment from a snapshot of the fully allocated storage segment, according to various embodiments of the present invention.

FIG. 9 illustrates an exemplary method of updating a snapshot of a fully allocated storage segment based upon data within the fully allocated storage segment, according to various embodiments of the present invention.

FIG. 10 illustrates an exemplary method of restoring the fully allocated storage segment from a snapshot of the fully allocated storage segment, according to various embodiments of the present invention.

FIG. 11 illustrates an exemplary method of updating a snapshot of a fully allocated storage segment based upon data within the fully allocated storage segment, according to various embodiments of the present invention.

FIG. 12 illustrates an exemplary method of restoring the fully allocated storage segment from a snapshot of the fully allocated storage segment, according to various embodiments of the present invention.

### DETAILED DESCRIPTION

A computer includes a storage segment fully allocated to an application. The storage segment initially includes a repeating initialization data pattern there within. After the application begins its workload, the application writes application data to a portion of the storage segment. A snapshot application takes a snapshot of the storage segment. After the snapshot, the application generates a post-snapshot-write to the storage segment. The snapshot application determines whether the post-snapshot-write modifies application data or modifies the repeating initialization data pattern. If the post-snapshot-write modifies the repeating initialization data pattern within the storage segment, the snapshot application blocks the repeating initialization data pattern from being copied and moved which resultantly blocks modification of the snapshot. If the post-snapshot-write modifies application data, the snapshot application copies and moves the application data to a destination storage location which resultantly modifies the snapshot to identify the destination storage location of the moved application data.

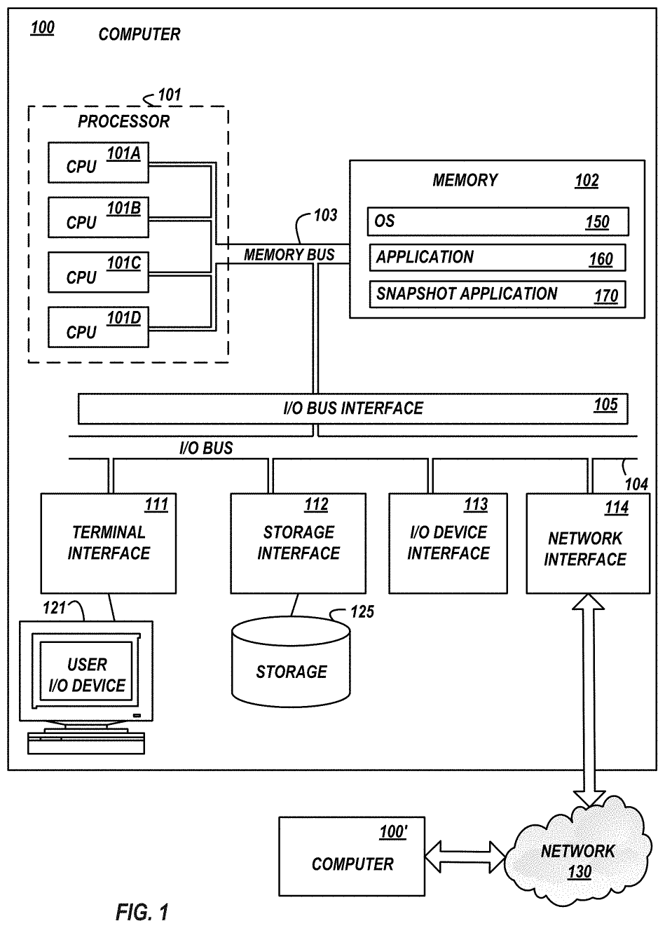

Referring to the Drawings, wherein like numbers denote like parts throughout the several views, FIG. 1 depicts a high-level block diagram representation of a computer 100 which may be connected to another computer 100′ via a network 130. The term “computer” is used herein for convenience only, and in various embodiments, is a general data handling system. The mechanisms and apparatus of embodiments of the present invention apply equally to any appropriate data handling system.

The major components of the computer 100 may comprise one or more processors 101, a main memory 102, a terminal interface 111, a storage interface 112, an I/O (Input/Output) device interface 113, and a network interface 114, all of which are communicatively coupled, directly or indirectly, for inter-component communication via a memory bus 103, an I/O bus 104, and an I/O bus interface 105. The computer 100 contains one or more general-purpose programmable central processing units (CPUs) 101A, 101B, 101C, and 101D, herein generically referred to as the processor 101. In an embodiment, the computer 100 contains multiple processors typical of a relatively large system; however, in another embodiment the computer 100 may alternatively be a single CPU system. Each processor 101 executes instructions stored in the main memory 102 and may comprise one or more levels of on-board cache.

In an embodiment, the main memory 102 may comprise a random-access semiconductor memory, buffer, cache, or other storage medium for storing or encoding data and programs. In another embodiment, the main memory 102 represents the entire virtual memory of the computer 100 and may also include the virtual memory of the other computer system 100′ coupled to the computer 100 or connected via network 130. The main memory 102 is conceptually a single monolithic entity, but in other embodiments the main memory 102 is a more complex arrangement, such as a hierarchy of caches and other memory devices. For example, memory 102 may exist in multiple levels of caches, and these caches may be further divided by function, so that one cache holds instructions while another holds non-instruction data, which is used by the processor or processors. Memory 102 may be further distributed and associated with different CPUs or sets of CPUs, as is known in any of various so-called non-uniform memory access (NUMA) computer architectures.

The main memory 102 stores or encodes an operating system 150, an application 160, and a snapshot application 170. Although the operating system 150, application 160, snapshot application 170 are illustrated as being contained within the memory 102 in the computer 100, in other embodiments some or all of them may be on different computer 100′ and may be accessed remotely, e.g., via network 130. The computer 100 may use virtual addressing mechanisms that allow the operating system 150, application 160, and snapshot application 170 of the computer 100 to behave as if they have access to a large, single storage entity instead of access to multiple, smaller storage entities.

Thus, while operating system 150, application 160, snapshot application 170 are illustrated as being contained within the main memory 102, these elements are not necessarily all completely contained in the same memory at the same time. Further, although operating system 150, application 160, snapshot application 170 are illustrated as being separate entities, in other embodiments some of them, portions of some of them, or all of them may be packaged together.

In an embodiment, operating system 150, an application 160, snapshot application 170 comprise instructions or statements that execute on the processor 101 or instructions or statements that are interpreted by instructions or statements that execute on the processor 101 to cause the processor 101 to perform functions further described herein.

The memory bus 103 provides a data communication path for transferring data among the processor 101, the main memory 102, and the I/O bus interface 105. The I/O bus interface 105 is further coupled to the system I/O bus 104 for transferring data to and from the various I/O units. The I/O bus interface 105 communicates with multiple I/O interfaces 111, 112, 113, and 114, which are also known as I/O processors (IOPs) or I/O adapters (IOAs), through the system I/O bus 104. The I/O interfaces support communication with a variety of storage and I/O devices. For example, the terminal interface 111 supports the attachment of one or more user I/O devices 121, which may comprise user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 121 and the computer 100 and may receive output data via the user output devices. For example, a user interface may be presented via the user I/O device 121, such as displayed on a display device, played via a speaker, or printed via a printer.

The storage interface 112 supports the attachment of one or more local storage devices or one or more peripheral storage systems, herein referred to a storage 125. In an embodiment, the storage 125 is local rotating magnetic disk drive storage device(s), local flash storage device(s), or any other local storage device. In other embodiments, storage 125 is one or more peripheral storage device(s) or system(s). In such embodiments, multiple peripheral storage device(s) or system(s) may be configured to appear as a single large storage device to computer 100.

The contents of the main memory 102, or any portion thereof, may be stored to and retrieved from the storage 125, as needed. The storage 125 may have a slower access time than does the memory 102, meaning that the time needed for computer 100 to read and/or write data from/to the memory 102 is less than the time needed for the computer 100 to read and/or write data from/to from storage 125.

The I/O device interface 113 provides an interface to any of various other input/output devices, such as display screens, printers, or the like. The network interface 114 provides one or more communications paths from the computer 100 to other data handling devices, such as computer 100′. Such paths may comprise, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer 100 may, in fact, contain multiple I/O bus interfaces 105 and/or multiple I/O buses 104. While multiple I/O interfaces are shown, which separate the system I/O bus 104 from various communications paths running to the various I/O devices, in other embodiments some or all the I/O devices are connected directly to one or more system I/O buses.

Storage interface 112, I/O interface 113, and/or network interface 114 may contain electronic components and logic to adapt or convert data of one protocol on I/O bus 104 to another protocol on another bus. Therefore, storage interface 112, I/O interface 113, and/or network interface 114 may connect a wide variety of devices to computer 100 and to each other such as, but not limited to, tape drives, optical drives, printers, disk controllers, other bus adapters, PCI adapters, workstations using one or more protocols including, but not limited to, Token Ring, Gigabyte Ethernet, Ethernet, Fibre Channel, SSA, Fiber Channel Arbitrated Loop (FCAL), Serial SCSI, Ultra3 SCSI, Infiniband, FDDI, ATM, 1394, ESCON, wireless relays, Twinax, LAN connections, WAN connections, high performance graphics, etc.

Though shown as distinct entities, the multiple I/O interfaces 111, 112, 113, and 114 or the functionality of the I/O interfaces 111, 112, 113, and 114 may be integrated into a similar device.

In various embodiments, the computer 100 is a multi-user mainframe computer system, a single-user system, a server computer or similar device that has little or no direct user interface but receives requests from other computer systems (clients). In other embodiments, the computer 100 is implemented as a desktop computer, portable computer, laptop or notebook computer, tablet computer, pocket computer, telephone, smart phone, pager, automobile, teleconferencing system, appliance, or any other appropriate type of electronic device.

In some embodiments, network 130 may be a communication network and may be any suitable communication network or combination of networks and may support any appropriate protocol suitable for communication of data and/or code to/from the computer 100. In various embodiments, the communication network may represent a data handling device or a combination of data handling devices, either connected directly or indirectly to the computer 100. In another embodiment, the communication network may support wireless communications. In another embodiment, the communication network may support hard-wired communications, such as a telephone line or cable. In another embodiment, the communication network may be the Internet and may support IP (Internet Protocol). In another embodiment, the communication network is implemented as a local area network (LAN) or a wide area network (WAN). In another embodiment, the communication network is implemented as a hotspot service provider network. In another embodiment, the communication network is implemented an intranet. In another embodiment, the communication network is implemented as any appropriate cellular data network, cell-based radio network technology, or wireless network. In another embodiment, the communication network is implemented as any suitable network or combination of networks.

In embodiments where storage 125 is peripheral to computer 100, a storage network may connect computer 100 and storage 125. Storage network may be a storage area network (SAN), or the like, which is a network which provides access to consolidated, block level data storage. The storage network is generally any high-performance network whose primary purpose is to enable the peripheral storage 125 to provide storage operations to computer 100. The storage network may be primarily used to allow for the peripheral storage 125 to be accessible to computer 100 so that the peripheral storage 125 appear to the operating system 150 as local device. A potential benefit of the storage network is that peripheral storage 125 may be treated as a pool of resources that can be centrally managed and allocated on an as-needed basis. Further, peripheral storage 125 may be highly scalable because additional storage capacity can be added as required.

OS 150, application 160 and/or snapshot application 170 may be distributed among multiple computers 100, 100′. For example, OS 150, application 160 and or snapshot application 170 may be running on each computer 100, 100′ and can access shared or distinct memory and/or storage.

Generally, computer 100′ may comprise some or all of the elements of the computer 100 and/or additional elements not included in computer 100.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

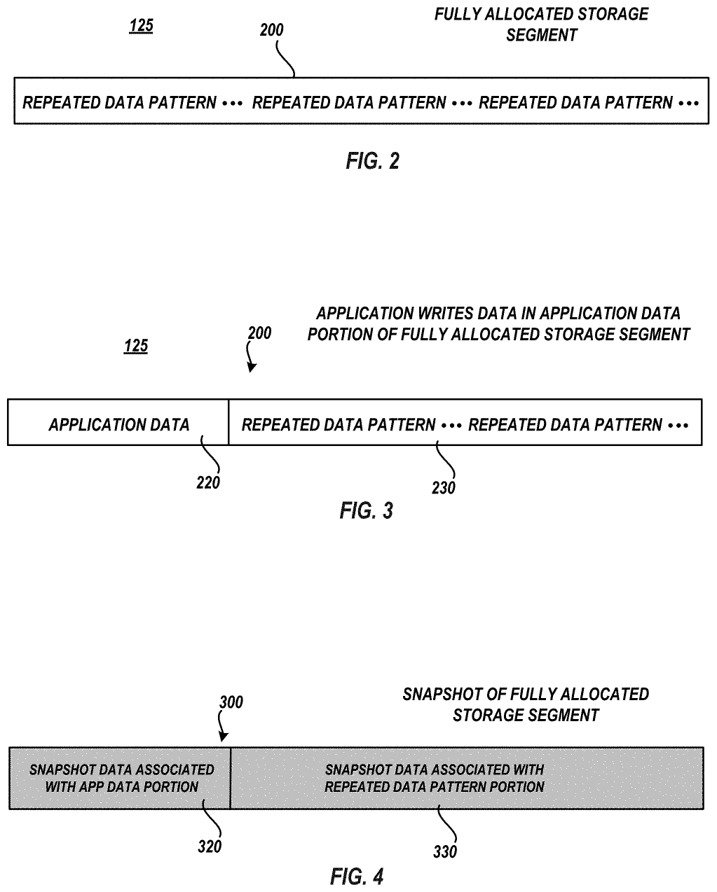

FIG. 2 illustrates a depiction of an exemplary fully allocated storage segment 200, according to various embodiments of the present invention. Storage segment 200 is generally a logical portion of storage 125. For example, storage segment 200 may be one or more partitions, volumes, logical units, blocks, files, pages, or the like.

Storage segment 200 is fully allocated to application 160 such that the entire storage segment 200 may be solely utilized by application 160 at the time of and after its allocation to application 160. That is, storage segment 200 is assigned to application 160, to the exclusion of other applications, so that application 160 may write application data to storage segment 200, read application data from storage segment 200, and or modify application data that it has previously written to storage segment 200. Storage segment 200 may be allocated to application 160 by application 160 itself, by OS 150, or the like.

When storage segment 200 is allocated to application 160, an initialization or allocation pattern of data, herein referred to as allocation data, is stored therein. For example, the allocation data within storage segment 200 is all zeros, is all ones, or is a predetermined repeating pattern. Such allocation data may be written to storage segment 200 by application 160, by OS 150, or the like.

FIG. 3 illustrates an exemplary fully allocated storage segment 200 prior to a snapshot being taken thereof, according to various embodiments of the present invention. Subsequent to storage segment 200 being allocated to application 160, application 160 begins utilizing such storage segment 200. As such, application 160 writes application data to an application data portion 220 of storage segment 200 thereby overwriting, modifying, copy-move-replace, displacing, or the like, the repeated data pattern previously within such portion. Generally, application data portion 220 of storage segment 200 is a logical portion of storage segment 200 that solely contains application data of application 160. Data within application data portion 220 is generally in a different state relative to the repeated data pattern that was previously stored therein. In other words, data within portion 220 is typically different than the related data pattern. As such, data within portion 220 has been deemed modified, subsequent to the application 160 writing application data thereto.

After application 160 has begun utilizing storage segment 200 but prior to a snapshot being taken of storage segment 200, storage segment 200 also includes the repeated data pattern within a repeated data portion 230. Generally, repeated data pattern portion 230 of storage segment 200 is a logical portion of storage segment 200 that solely contains the repeated data pattern. The data within repeated data pattern portion 230 is generally the same state relative to the previous repeated data pattern associated with the storage segment 200 being allocated to application 160. As such, data within portion 230 has been deemed non-modified, subsequent to the application 160 writing application data to another portion 220 of the storage segment 200.

FIG. 4 illustrates an exemplary snapshot 300 of the fully allocated storage segment 200, according to various embodiments of the present invention. Snapshot application 170 takes snapshot 300 of segment 200 according to various techniques known in the art. The snapshot 300 depicted in FIG. 4 is of segment 200 as exemplary depicted in FIG. 3. Snapshot 300 generally contains an application data portion 320 which contains snapshot data associated with the application data within portion 220 of segment 200 and a repeated data pattern portion 320 which contains snapshot data associated with the repeated data pattern within portion 230 of segment 200. Various forms of snapshot data are known in the art, such as metadata, pointers, or the like.

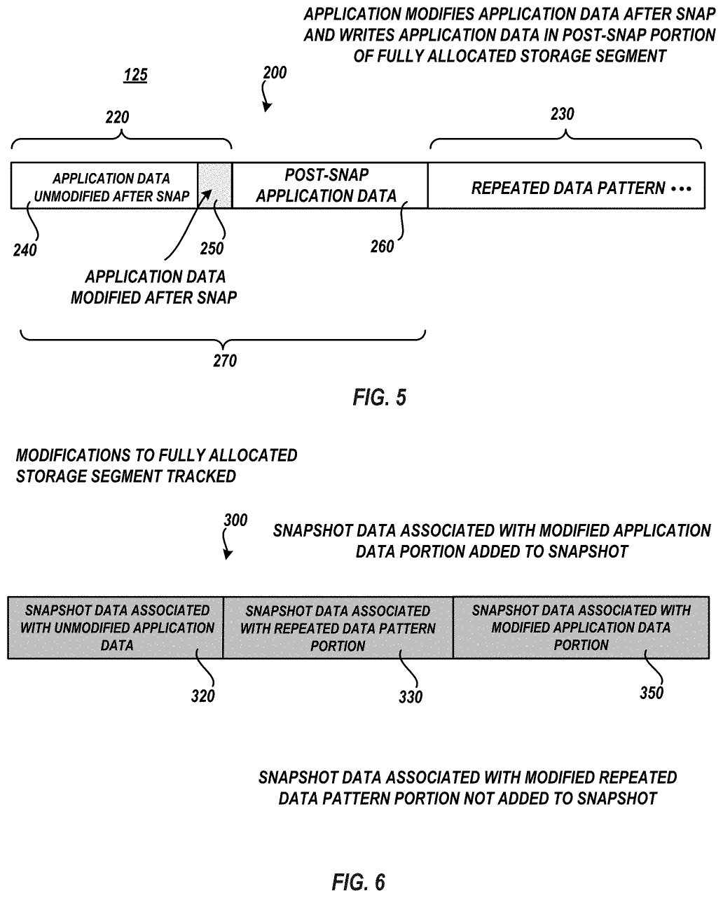

FIG. 5 illustrates an exemplary fully allocated storage segment 200 that is modified after snapshot 300, according to various embodiments of the present invention. Subsequent to the snapshot 300, application 160 continues utilizing storage segment 200.

In a first type of continued usage, application 160 writes application data to an application data portion 260 of storage segment 200 thereby overwriting, modifying, copy-move-replace, displacing, or the like, the repeated data pattern previously within such portion. Generally, application data portion 260 of storage segment 200 is a logical portion of storage segment 200 that solely contains application data of application 160. Data within application data portion 260 is generally in a different state relative to the repeated data pattern that was previously stored therein. In other words, data within portion 260 is typically different than the related data pattern. As such, data within portion 260 has been deemed modified, subsequent to the application 160 writing application data thereto.

After application 160 continued utilization of storage segment 200 and after snapshot 300 was taken of storage segment 200, the size of repeated data portion 230 has decreased relative to the size of data portion 230 prior to application 160 continued utilization of storage segment 200 and prior to snapshot 300. For example, repeated data portion 230 has decreased the size of application data portion 260.

After application 160 continued utilization of storage segment 200 and after snapshot 300 was taken of storage segment 200, application data is contained within application data portion 220 and within application data portion 260. Application data portion 220 and application data portion 260 may be collectively referred to as application data portion 270.

In a second type of continued usage, application 160 modifies previously written application data in a modified application data portion 250 of storage segment 200 thereby overwriting, modifying, copy-move-replace, displacing, or the like, the application data previously within such portion. Generally, application data portion 250 of storage segment 200 is a logical portion of storage segment 200 that solely contains application data of application 160 that was modified after snapshot 300. Data within application data portion 250 is generally in a different state relative to the previous application data stored therein. As such, data within portion 250 has been deemed modified, subsequent to the application 160 writing application data thereto.

After application 160 continued utilization of storage segment 200 and after snapshot 300 was taken of storage segment 200, storage segment 200 may also include application data portion 240. Generally, application data portion 240 of storage segment 200 is a logical portion of storage segment 200 that solely contains application data. The application data within portion 240 is generally the same state relative to the application data prior to snapshot 300 and prior to application 160 continued utilization of storage segment 200. As such, data within portion 240 has been deemed non-modified.

After application 160 continued utilization of storage segment 200 and after snapshot 300 was taken of storage segment 200, application data portion 220 may contain modified application data portion 250 and non-modified application data portion 240.

FIG. 6 illustrates the snapshot 300 of the fully allocated storage segment when application data and initialization pattern data have been modified after the time of the snapshot 300, according to various embodiments of the present invention. Generally, snapshot application 170 tracks the modifications to storage segment 200 after the snapshot 300 and generally augments the snapshot 300 when needed so as to be able to recreate the segment 200 as that segment 200 existed at the point in time of snapshot 300. For example, previous data contained in segment 200 at the point in time of snapshot 300 may be copied, moved, and replaced with new data. The snapshot application 170 tracks and adds snapshot data associated with the modified data (e.g., the new location to which this previous data was moved, or the like) so as to recreate the segment 200 as it existed at the point in time of snapshot 300.

According to embodiments of the invention, snapshot application 170 tracks changes to segment 200 and augments the snapshot 300 with snapshot data associated with modified application data and does not augment the snapshot 300 with any snapshot data associated with modified repeated data pattern. Application 170 may augment the snapshot 300 by adding snapshot data associated with modified application data to a modified application data portion 350 within snapshot 300.

In an implementation, the snapshot application 170 is notified of the repeated data pattern so that when snapshots are taken the snapshot application 170 knows that modifications to the repeated data pattern may be disregarded. For example, when copy on write operations are triggered, the snapshot application 170 may determined the content of the existing data matches that of the repeated data pattern and may block further copy on write operations associated therewith.

Here, as the snapshot application 170 is aware of the distinction of application 160 modifying application data or repeated data, the snapshot 170 can disregard augmenting the snapshot 300 with snapshot data associated with modified repeated data pattern. Such technique aids in avoiding unnecessary processor 101 utilization leading to improved computer 100 performance.

In a particular example of the benefits of the embodiments, consider a clustered database application which has created 100's of 4 TB fully allocated files. These files are fully allocated where the database application writes the initialization pattern (e.g., all “0”, all “1” to the files, or alternatively, writes some specific pattern) to the files. When the database application starts operating over these files, it starts incrementally writing the database pages (which may be about 4K to few MB in size) to the fully allocated files. After few days of production, the database application has written 500 GB worth of database pages to the underlying allocated files. At such time, the files contain 500 GB worth of database data and 3.5 TB worth of the initialization pattern. Now the snapshot application takes a database snapshot which results in the snapshot application taking the snapshot of the files. Post the snapshot operation, the database application resumes and starts writing “new” pages to the files. At such time the database may start experiencing performance problems. When a snapshot on a file is taken, copy on write may be triggered only when existing data is modified by the database. As the database application has written new pages to the files, the copy on write logic of the snapshot application is triggered and the database faces performance issues because the snapshot application is not aware that the database is writing new pages to the existing initialization pattern (i.e., an essentially brand-new write) and not an existing replace of prior non-initialization data of the database. Since the snapshot application is not aware, it continues to treat the initialization pattern as existing data in the file and starts doing the copy on write operation over all new writes by the database directly impacting the performance.

In a first implementation, the snapshot application 170 is cognizant of the initialization pattern so that when the snapshots are taken and subsequently during a write, when the copy on write operation is triggered, the initialization pattern is ignored by the copy on write operations. As such, when the initial set of fully allocated storage structures 200 are created, the initialization pattern is communicated to the snapshot application 170. For example, the initialization pattern is added to a file attribute that is readable by snapshot application 170. Therefore, when snapshots are taken and the copy on write operation is triggered, the snapshot application 170 verifies the existing content of the storage structure 200 matches that of the initialization pattern and if so skips the copy on write operations. Such approach helps avoiding unnecessary processor 101 utilization, leading to improve the performance.

In another implementation, the snapshot application 170 is provided an address range of the structure 200 wherein application data has been written to (as opposed to the address range which contains the initiation pattern). In this approach, the application 160 knows that it has only written application data to certain portions of the structure 200. When a snapshot is triggered, the application 160 may pass such address range associated with the written application data and the copy on write operations of snapshot application 170 are upon only the range associated with the written application data. This significantly improves the performance. Such approach helps avoiding unnecessary processor 101 utilization, leading to improve the performance.

Further implementations of the concepts of the snapshot application 170 augmenting snapshot 300 with snapshot data associated with modified application data and not augmenting the snapshot 300 with any snapshot data associated with modified repeated data pattern are presented herein.

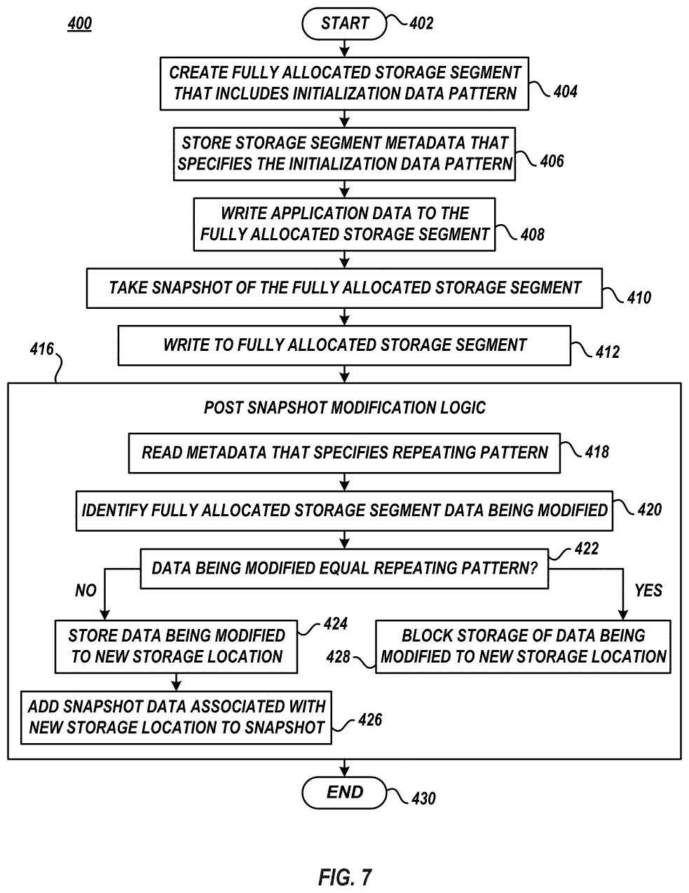

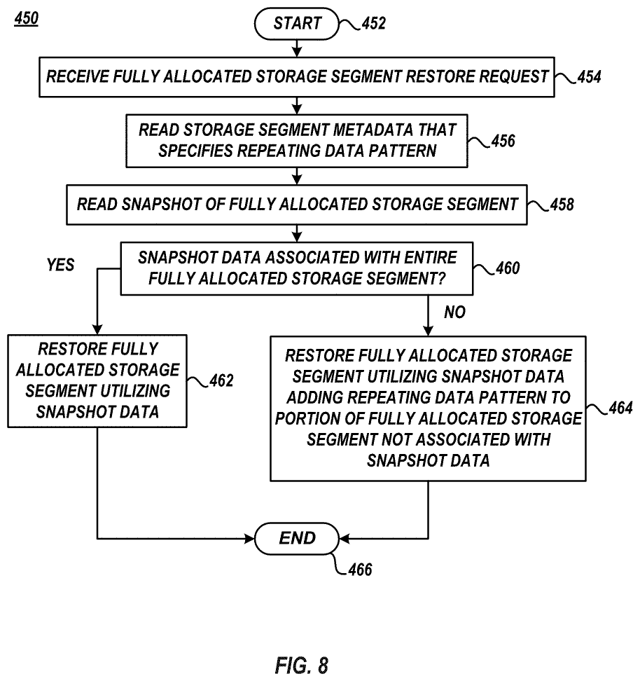

FIG. 7 illustrates an exemplary method 400 of updating a snapshot 300 of a fully allocated storage segment 200 based upon data within the fully allocated storage segment 200, according to various embodiments of the present invention. Method 400 may be enacted by processor 101 evoking the program instructions of OS 150, application 160, and/or snapshot application 170. Method 400 begins at block 402 and continues with creating a fully allocated storage segment 200 that includes a repeating data pattern there within (block 404). For example, OS 150 and/or application 160 fully allocates one or more storage segment(s) 200 that contain an repeating initialization pattern to application 160.

Method 400 may continue with storing storage segment 200 metadata that specifies the repeating initialization pattern (block 406). The storage segment 200 metadata is metadata that is generally associated with storage segment 200. For example, application 160 updates the attributes of storage segment 200 with the repeating initialization pattern.

Method 400 may continue with application 160 writing application data to storage segment 200 (block 408). For example, application 160 begins its workload and writes associated application data to portion 220 of segment 200 leaving another portion 230 of segment 200 containing the repeating initiation pattern.

Method 400 may continue with snapshot application 170 taking a snapshot 300 of storage segment(s) 200 (block 410). For example, snapshot application 170 takes snapshot 300 which contains snapshot data associated with portion 220 of segment 200 and contains snapshot data associated with portion 230 of segment 200. The snapshot data may be addresses, pointers, or the like, as is known in the art.

Method 400 may continue with application 160 generating a write to storage segment 200 after snapshot 300 has been taken (block 412). For example, application 160 may write application data, and thereby modify existing application data, within portion 250 of segment 200 or may write application data, and thereby modify the existing repeating initialization pattern, within portion 260 of segment 200.

Upon such write, snapshot application 170 conducts one or more post snapshot modification operations (block 416). In other words, the write to storage segment 200 after snapshot 300 has been taken triggers post snapshot modification operations. For example, copy on write operations of the snapshot application 170 are triggered upon the write to storage segment 200 after snapshot 300 has been taken.

Method 400 may continue with snapshot application 170 determining the applicable storage segment(s) 200 that is being modified (block 420) and by reading the metadata that specifies the repeating data pattern within the applicable segment(s) 200 (block 418). For example, snapshot application 170 and reads the metadata associated with segment 200 to determine the initialization pattern of that segment 200.

Method 400 may continue with snapshot application 170 determining if the data within storage segment 200 that is being modified equals the initialization pattern (block 422). For example, snapshot application 170 may determine that the data being modified is pre-existing application data or may determine that the data being modified is the repeating initialization pattern.

Method 400 may continue with storing the data that is being modified to a new storage location if it is determined that the data being modified is not the repeating initialization pattern (block 428). For example, snapshot application 170 that the data being modified is pre-existing application and resultantly copies the data being modified and stores such data to a new location within storage 125. Subsequently, application 160 modifies (e.g., writes over, or the like) the pre-existing application data that is to be modified according to the write of block 412. Generally, the new storage location is any location(s) within storage 125 not within storage segment 200.

Method 400 may continue with snapshot application 170 augmenting the snapshot 300 with the new location(s) of the pre-existing application data (block 426). For example, the address(es) of or pointer(s) to the pre-existing data at the new location within storage 125 is added to portion 350 of snapshot 300.

Method 400 may continue with blocking the storage of the data that is being modified to a new storage location if it is determined that the data being modified is the repeating initialization pattern (block 428). For example, copy on write operations of the snapshot application 170 are disregarded or blocked if it is the repeating initialization pattern within segment 200 being modified by the write of block 412. Method 400 may end at block 430.

In a particular implementation of method 400, when the copy on write operations of snapshot application 170 are triggered, the snapshot application 170 identifies the storage segment 200 that being written to, reads the attribute associated with the storage segment 200 to determine the particular initialization pattern, determines if the data within segment 200 that is to be modified is the initialization pattern, cancels or blocks further copy on write operations if the data within segment 200 that is to be modified is the initialization pattern, and conducts further copy on write operations if the data within segment 200 that is to be modified is application data.

As described, method 400 allows for snapshot 300 to be modified or augmented with snapshot data associated with new application data (e.g., the new storage location(s) of the moved pre-existing application data previously within segment 200 that is to be modified, etc.) and to not be modified or augmented when the existing data within segment 200 that is to be modified is the repeated initialization pattern. As such, method 400 specifies a technique to augment snapshot 300 based upon the type of data within segment 200 that is being modified.

FIG. 8 illustrates an exemplary method 450 of restoring the fully allocated storage segment 200 from a snapshot 300 of the fully allocated storage segment 200, according to various embodiments of the present invention. Method 450 may be enacted by processor 101 evoking the program instructions of OS 150, application 160, and/or snapshot application 170. Method 450 begins at block 452 and continues with snapshot 170 application receiving a fully allocated storage segment 200 restore request (block 454). The fully allocated storage segment 200 restore request may be made by the OS 150, application 160, or by another application and generally identifies which storage segment 200 that is to be restored.

Method 450 may continue with snapshot application 170 reading the storage segment metadata that specifies the initialization pattern of the storage segment 200 that is to be restored (block 456). For example, application 170 may query the appropriate attribute of segment 200 that specifies the initialization pattern of the associated segment 20.

Method 450 may continue with snapshot application 170 reading the snapshot 300 of the segment 200 that is to be restored (block 458) and determining whether there is snapshot data associated with the entire storage segment 200 (block 460). For example, snapshot application 170 may determine that there is no snapshot data associated with portion 260 of storage segment. That is, that snapshot application 170 may determine that copy on write processes were not carried out for the modified initialization pattern data overwritten by the application data within portion 260 of segment 200.

Method 450 may continue with snapshot application 170 determining that there is snapshot data that is associated with the entire storage segment 200 and utilizing such snapshot data to restore the fully allocated storage segment (block 462). For example, snapshot application 170 may determines that there is no portion 260 of storage segment 200 after the point in time of snapshot 300 and that the portion 330 of snapshot 300 is associated with the portion 230 of segment 200 prior to the point in time of snapshot 300. Therefore, snapshot application 170 may reconstruct structure 200 utilizing portions 320, 330, and/or 350 of snapshot 300.

Method 450 may continue with snapshot application 170 determining that there missing or nonexistent snapshot data associated with one or more portions of segment 200 and therefore utilizes the snapshot 300 to reconstruct storage segment 300 in addition to adding the repeated initialization data pattern to the one or more portions of segment 200 that which no snapshot data is associated (block 464). For example, snapshot application 170 may determine that there is no snapshot data associated with portion 260 of storage segment 200. That is, that snapshot application 170 may determine that copy on write processes were not carried out for the modified initialization pattern data overwritten by the application data within portion 260 of segment 200. Therefore, snapshot application 170 may reconstruct structure 200 utilizing portions 320, 330, and/or 350 of snapshot 300 in addition to adding the initialization pattern data to portion 260 of segment 200 that which no snapshot data was associated. Method 450 ends at block 466.

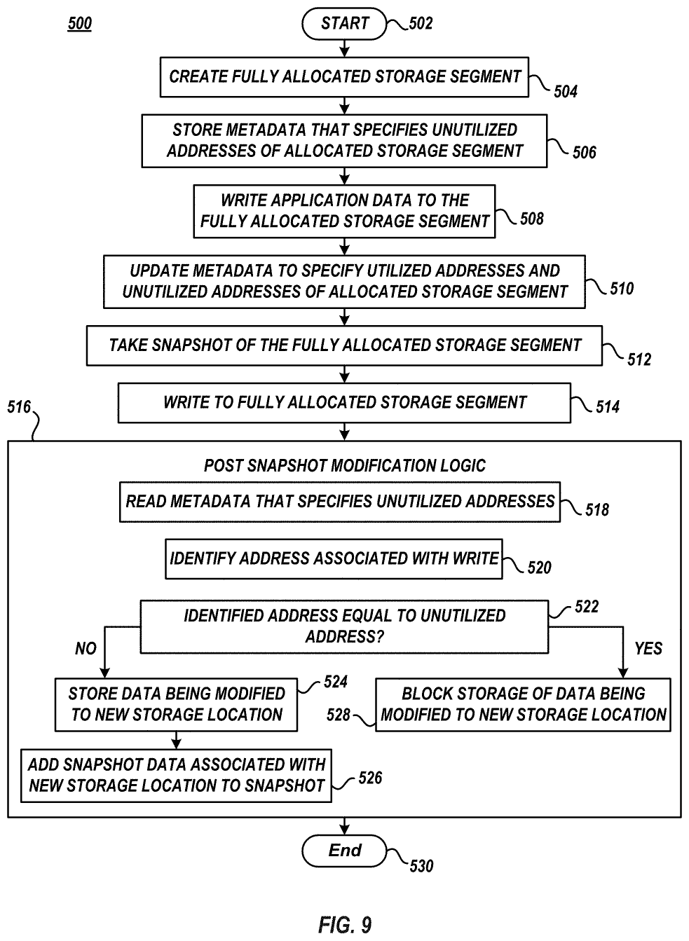

FIG. 9 illustrates an exemplary method 500 of updating a snapshot 300 of a fully allocated storage segment 200 based upon data within the fully allocated storage segment 200, according to various embodiments of the present invention. Method 500 may be enacted by processor 101 evoking the program instructions of OS 150, application 160, and/or snapshot application 170. Method 500 begins at block 502 and continues with creating a fully allocated storage segment 200 that includes a repeating initialization data pattern there within (block 504). For example, OS 150 and/or application 160 fully allocates one or more storage segment(s) 200 that contain a repeating initialization pattern to application 160.

Method 500 may continue with storing storage segment 200 metadata that specifies that storage segment 200 has not been utilized by the application 160 to which it is allocated and that none of the data within storage segment 200 is application data (block 506). The storage segment 200 metadata is metadata that is generally associated with storage segment 200. For example, application 160 stores an address range that identifies the entire storage segment 200 and indicates such address range as not yet utilized by application 160. In some embodiments, method 600 may also include storing metadata that specifies the repeating initiation pattern associated with the storage segment 200. For example, application 160 may store the initialization data pattern within an attribute of the storage segment 200.

Method 500 may continue with application 160 writing application data to storage segment 200 (block 508). For example, application 160 begins its workload and writes associated application data to portion 220 of segment 200 leaving another portion 230 of segment 200 containing the repeating initiation pattern.

Method 500 may continue with application 160 updating the metadata to specify an address range associated with the portion of storage segment 200 that was utilized by application 160 and to specify an address range associated with the portion of storage segment 200 that has not yet been utilized by application 160 (block 510). For example, application 160 updates the metadata to specify a first address range that identifies portion 220 of storage segment 200 that includes application data and to specify a second address range that identifies portion 230 of storage segment 200 that includes the repeated initiation pattern.

Method 500 may continue with snapshot application 170 taking a snapshot 300 of storage segment(s) 200 (block 512). For example, snapshot application 170 takes snapshot 300 which contains snapshot data associated with portion 220 of segment 200 and contains snapshot data associated with portion 230 of segment 200. The snapshot data may be addresses, pointers, or the like, as is known in the art.

Method 500 may continue with application 160 generating a write to storage segment 200 after snapshot 300 has been taken (block 514). For example, application 160 may write application data, and thereby modify existing application data, within portion 250 of segment 200 or may write application data, and thereby modify the existing repeating initialization pattern, within portion 260 of segment 200.

Upon such write, snapshot application 170 conducts one or more post snapshot modification operations (block 516). In other words, the write to storage segment 200 after snapshot 300 has been taken triggers post snapshot modification operations. For example, copy on write operations of the snapshot application 170 are triggered upon the write to storage segment 200 after snapshot 300 has been taken.

Method 500 may continue with snapshot application 170 determining the applicable storage segment(s) 200 that is being modified and by reading the metadata that specifies the unutilized address range of segment 200 (block 518). For example, snapshot application 170 and reads the metadata associated with segment 200 to determine the address range of segment 200 that has not yet been utilized by application 160.

Method 500 may continue with snapshot application 170 identifying the address(es) associated with the write of block 508 (block 520) and determining whether the address(es) associated with the write of block 508 is equal to or included within the unutilized address range (block 522). For example, snapshot application 170 may determine that the data being modified is pre-existing application data (i.e., the address of segment 200 associated with the write of block 508 is included within the utilized address range thereby indicating the data being modified by such write is application data) or may determine that the data being modified is the repeating initialization pattern (i.e., the address of segment 200 associated with the write of block 508 is included within the unutilized address range thereby indicating the data being modified by such write is the repeating initialization pattern).

Method 500 may continue with storing the data that is being modified to a new storage location if it is determined that the address(es) associated with the write of block 508 are not equal to or are not included within the unutilized address range (block 524). For example, snapshot application 170 determines that the data being modified is pre-existing application data and resultantly copies the data being modified and stores such data to a new location within storage 125. Subsequently, application 160 modifies (e.g., writes over, or the like) the pre-existing application data that is to be modified according to the write of block 508. Generally, the new storage location is any location(s) within storage 125 not within storage segment 200.

Method 500 may continue with snapshot application 170 augmenting the snapshot 300 with the new location(s) of the pre-existing application data (block 526). For example, the address(es) of or pointer(s) to the pre-existing data at the new location within storage 125 is added to portion 350 of snapshot 300.

Method 500 may continue with blocking the storage of the data that is being modified to a new storage location if it is determined that the address(es) associated with the write of block 508 are equal to or are included within the unutilized address range (block 528). For example, copy on write operations of the snapshot application 170 are disregarded or blocked if it is the repeating initialization pattern within segment 200 being modified by the write of block 508. Method 500 may end at block 530.

In a particular implementation of method 500, application 160 may allocate segment 200 using an fallocate( )system call or can choose to write zeroes or ones to segment 200. None of the data within segment 200 is useful or significant at this point. Subsequently, application 160 writes an extended attribute segment 200 that indicates that none of the segment 200 data is significant. For example, the unused address range fully addresses the entire segment 200. In some implementations, a fcnt1( ) subcommand can also be defined and used by the application 160 to supply this unused address range.

Subsequently, application 160 begins its workload thereby writing application data to portion 220 of segment 200. As application 160 continues to write application data to segment 200, it updates the extended attribute which specifies the addresses that do not contain significant data (i.e. the unused address range). The address(es) of the portion(s) of segment 200 that are written by application 160 are removed from the unused extended attribute. Thus, application 160 maintains a real time indication of the unused addresses of segment 200. Application 160 updating this extended attribute, in and of itself, may not trigger copy on write operations of segment 200.

Subsequently, snapshot application 170 takes a snapshot 300 of segment 200. After the snapshot 300, when a write comes to segment 200, the following copy on write operations of snapshot 300 are triggered. As part of the snapshot processing, a write to segment 200 results in a segment 200 inode getting copied to the snapshot 300 (if it's not already copied). This also copies the unused addresses extended attribute to the inode. This has the effect of copying all the unused portions of segment 200 to snapshot 300. If the existing write address is not part of the unused addresses, the to be modified data in segment 200 is application data and copy on write operations associated therewith are performed. If the existing write address is part of the unused addresses, the to be modified data in segment 200 is the initialization pattern and copy on write operations associated therewith are blocked.

As described, method 500 allows for snapshot 300 to be modified or augmented with snapshot data associated with new application data (e.g., the new storage location(s) of the moved pre-existing application data previously within segment 200 that is to be modified, etc.) and to not be modified or augmented when the existing data within segment 200 that is to be modified is the repeated initialization pattern. As such, method 500 specifies a technique to augment snapshot 300 based upon the type of data within segment 200 that is being modified.

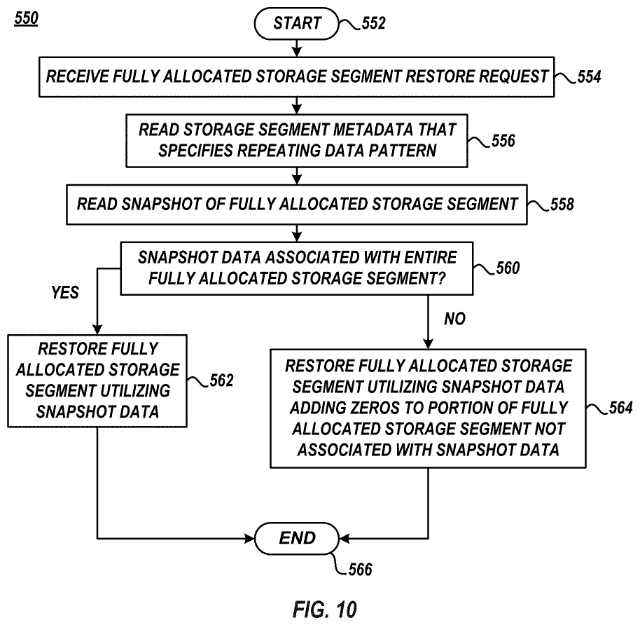

FIG. 10 illustrates an exemplary method 550 of restoring the fully allocated storage segment 200 from a snapshot 300 of the fully allocated storage segment 200, according to various embodiments of the present invention. Method 550 may be enacted by processor 101 evoking the program instructions of OS 150, application 160, and/or snapshot application 170. Method 550 begins at block 552 and continues with snapshot application 170 receiving a fully allocated storage segment 200 restore request (block 554). The fully allocated storage segment 200 restore request may be made by the OS 150, application 160, or by another application and generally identifies which storage segment 200 that is to be restored.

Method 550 may continue with snapshot application 170 reading the storage segment metadata that specifies the unused address range of the segment 200 (block 556). For example, application 170 may query the appropriate attribute of segment 200 that specifies the address of segment 200 that application 160 has not written application data thereto.

Method 550 may continue with snapshot application 170 reading the snapshot 300 of the segment 200 that is to be restored (block 558) and determining whether there is snapshot data associated with the entire storage segment 200 (block 560). For example, snapshot application 170 may determine that there is no snapshot data associated with portion 260 of storage segment. That is, that snapshot application 170 may determine that copy on write processes were not carried out for the modified initialization pattern data overwritten by the application data within portion 260 of segment 200.

Method 550 may continue with snapshot application 170 determining that there is snapshot data that is associated with the entire storage segment 200 and utilizing such snapshot data to restore the fully allocated storage segment (block 562). For example, snapshot application 170 may determine that there is no portion 260 of storage segment 200 after the point in time of snapshot 300 and that the portion 330 of snapshot 300 is associated with the portion 230 of segment 200 prior to the point in time of snapshot 300. Therefore, snapshot application 170 may reconstruct structure 200 utilizing portions 320, 330, and/or 350 of snapshot 300.

Method 550 may continue with snapshot application 170 determining that there missing or nonexistent snapshot data associated with one or more portions of segment 200 and therefore utilizes the snapshot 300 to reconstruct storage segment 300 in addition to adding the repeated initialization data pattern to the one or more portions of segment 200 that which no snapshot data is associated (block 564). For example, snapshot application 170 may determine that there is no snapshot data associated with portion 260 of storage segment 200. That is, that snapshot application 170 may determine that copy on write processes were not carried out for the modified initialization pattern data overwritten by the application data within portion 260 of segment 200. Therefore, snapshot application 170 may reconstruct structure 200 utilizing portions 320, 330, and/or 350 of snapshot 300 in addition to adding the initialization pattern data to portion 260 of segment 200 that which no snapshot data was associated. Method 550 ends at block 566.

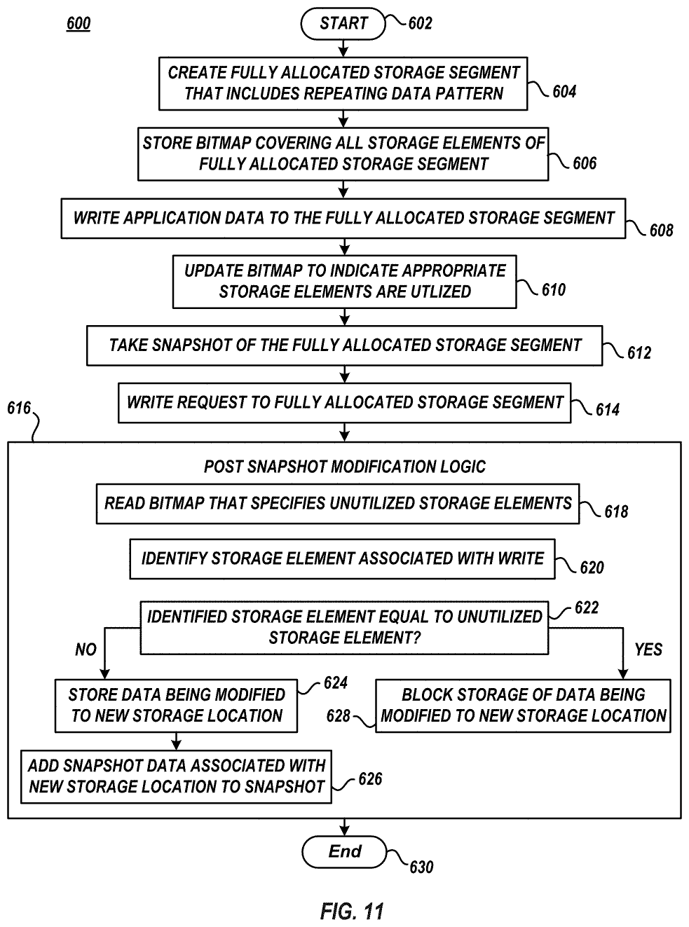

FIG. 11 illustrates an exemplary method 600 of updating a snapshot 300 of a fully allocated storage segment 200 based upon data within the fully allocated storage segment 200, according to various embodiments of the present invention. Method 600 may be enacted by processor 101 evoking the program instructions of OS 150, application 160, and/or snapshot application 170. Method 600 begins at block 602 and continues with creating a fully allocated storage segment 200 that includes a repeating initialization data pattern there within (block 604). For example, OS 150 and/or application 160 fully allocates one or more storage segment(s) 200 that contain a repeating initialization pattern to application 160.

Method 600 may continue with storing a storage segment 200 bitmap that specifies that storage segment 200 has not been utilized by the application 160 to which it is allocated and that none of the data within storage segment 200 is application data (block 606). The storage segment 200 bitmap is a map that is generally associated with storage segment 200 that identifies, covers, or maps all of the storage segment to identify which portions of storage segment store application data and which portions of the storage segment store the repeating data pattern. For example, application 160 stores a bitmap that identifies the entire storage segment 200 and indicates all such portions of the segment 200 as not yet utilized by application 160.

In some embodiments, method 600 may also include storing metadata that specifies the repeating initiation pattern associated with the storage segment 200. For example, application 160 may store the initialization data pattern within an attribute of the storage segment 200.

Method 600 may continue with application 160 writing application data to storage segment 200 (block 608). For example, application 160 begins its workload and writes associated application data to portion 220 of segment 200 leaving another portion 230 of segment 200 containing the repeating initiation pattern.

Method 600 may continue with application 160 updating the bitmap to specify additional portions of storage segment 200 that was utilized by application 160 and to specify portions of storage segment 200 that have not yet been utilized by application 160 (block 610). For example, application 160 updates the bitmap that identifies portion 220 of storage segment 200 that includes application data and to identify portion 230 of storage segment 200 that includes the repeated initiation pattern.

Method 600 may continue with snapshot application 170 taking a snapshot 300 of storage segment(s) 200 (block 612). For example, snapshot application 170 takes snapshot 300 which contains snapshot data associated with portion 220 of segment 200 and contains snapshot data associated with portion 230 of segment 200. The snapshot data may be addresses, pointers, or the like, as is known in the art.

Method 600 may continue with application 160 generating a write to storage segment 200 after snapshot 300 has been taken (block 614). For example, application 160 may write application data, and thereby modify existing application data, within portion 250 of segment 200 or may write application data, and thereby modify the existing repeating initialization pattern, within portion 260 of segment 200.

Upon such write, snapshot application 170 conducts one or more post snapshot modification operations (block 616). In other words, the write to storage segment 200 after snapshot 300 has been taken triggers post snapshot modification operations. For example, copy on write operations of the snapshot application 170 are triggered upon the write to storage segment 200 after snapshot 300 has been taken.

Method 600 may continue with snapshot application 170 determining the applicable storage segment(s) 200 that is being modified and by reading the bitmap that specifies the unutilized address range of segment 200 (block 618). For example, snapshot application 170 reads the bitmap associated with segment 200 to determine the portions of segment 200 that has not yet been utilized by application 160.

Method 600 may continue with snapshot application 170 identifying the portion to which the data associated with the write of block 508 is to be written (block 620) and determining whether this portion is equal to or included within the unutilized portions of segment 200 identified in the bitmap (block 622). For example, snapshot application 170 may determine that the data being modified is pre-existing application data (i.e., the portion of segment 200 to which the data of the write of block 608 is included within the utilized portion of segment 200 identified by the bitmap; thereby indicating the data being modified by the write is application data) or may determine that the data being modified is the repeating initialization pattern (i.e., the portion of segment 200 to which the data of the write of block 608 is not included within the utilized portion of segment 200 identified by the bitmap; thereby indicating the data being modified by the write is the repeating initialization pattern).

Method 600 may continue with storing the data that is being modified to a new storage location if it is determined that the portion of segment 200 to which the data is to be written is not equal to or is not included within the unutilized portion identified by the bitmap (block 624). For example, snapshot application 170 determines that the data being modified is pre-existing application data and resultantly copies the data being modified and stores such data to a new location within storage 125. Subsequently, application 160 modifies (e.g., writes over, or the like) the pre-existing application data that is to be modified according to the write of block 508. Generally, the new storage location is any location(s) within storage 125 not within storage segment 200.

Method 600 may continue with snapshot application 170 augmenting the snapshot 300 with the new location(s) of the pre-existing application data (block 626). For example, the address(es) of or pointer(s) to the pre-existing data at the new location within storage 125 are added to portion 350 of snapshot 300.

Method 600 may continue with blocking the storage of the data that is being modified to a new storage location if it is determined that the portion of segment 200 to which the data is to be written is equal to or is included within the unutilized portions identified by the bitmap (block 628). For example, copy on write operations of the snapshot application 170 are disregarded or blocked if it is the repeating initialization pattern within segment 200 being modified by the write of block 508. Method 500 may end at block 530.

In an implementation of method 500, application 160 may create one or more fully large allocated storage segments 200. A bitmap covering all portions of either each individual segment 200 or a group of multiple segments 200 is created and stored in an extended attribute of one or more of the storage segments 200. Initially, the bitmap may be blank or have a null set of contents, indicating no application data has been written to any portion of the storage segment(s) 200. The granularity of the bitmap can be predefined. For example, one bit may equal one block, or one bit may equal eight blocks, or the like. The initialization pattern may also be stored in an extended attribute of the segment 200.

Subsequently, application 160 begins its workload thereby writing application data to portion 220 of segment 200. As application 160 continues to write application data to segment 200, it updates the bitmap within the extended attribute to specify the portions of segment 200 that do not contain significant data (i.e. the portions of segments(s) 200 that include the repeating application data). The portions of segment 200 that contain application may also be specified within the bitmap. Thus, application 160 maintains a real time indication of the unused portions of storage segment(s). Application 160 updating the bitmap, in and of itself, may not trigger copy on write operations of segment 200.

Subsequently, snapshot application 170 takes a snapshot 300 of segment 200. After the snapshot 300, when a write comes to segment 200, the following copy on write operations of snapshot 300 are triggered. As part of the snapshot processing, a write to segment 200 results in a segment 200 inode getting copied to the snapshot 300 (if it's not already copied). This also copies the bitmap and initialization pattern to the inode. This has the effect of copying all the unused portions of segment 200 to the snapshot 300 without allocating segment 200 portions for them, or copying the segment 200 data. If the portion of segment 200 associated with the write is not part of the unused portions of segment 200 identified by the bitmap, the to be modified data in segment 200 is application data and copy on write operations associated therewith are performed. If the portion of segment 200 associated with the write is within of the unused portions of segment 200 identified by the bitmap, the to be modified data in segment 200 is the initialization pattern and copy on write operations associated therewith are blocked.

As described, method 600 allows for snapshot 300 to be modified or augmented with snapshot data associated with new application data (e.g., the new storage location(s) of the moved pre-existing application data previously within segment 200 that is to be modified, etc.) and to not be modified or augmented when the existing data within segment 200 that is to be modified is the repeated initialization pattern. As such, method 600 specifies a technique to augment snapshot 300 based upon the type of data within segment 200 that is being modified.

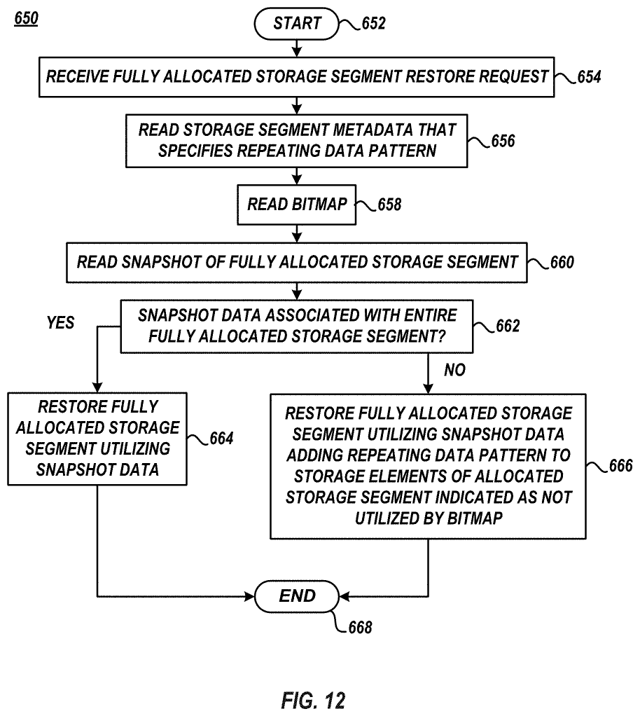

FIG. 12 illustrates an exemplary method 650 of restoring the fully allocated storage segment 200 from a snapshot 300 of the fully allocated storage segment 200, according to various embodiments of the present invention. Method 650 may be enacted by processor 101 evoking the program instructions of OS 150, application 160, and/or snapshot application 170. Method 650 begins at block 552 and continues with snapshot application 170 receiving a fully allocated storage segment 200 restore request (block 654). The fully allocated storage segment 200 restore request may be made by the OS 150, application 160, or by another application and generally identifies which storage segment 200 that is to be restored.

Method 650 may continue with snapshot application 170 reading the storage segment metadata that specifies the repeating initialization data pattern of the segment 200 (block 656). For example, application 170 may query the appropriate attribute of segment 200 that specifies the repeating initialization data pattern of the segment 200.

Method 650 may continue with snapshot application 170 reading the bitmap that identifies the unutilized portions of segment 200 (block 658). For example, application 170 may query the appropriate attribute of segment 200 that contains the bitmap which specifies portions of segment 200 that are utilized and therefore contain application data and the portions of segment 200 that are not utilized and therefore contain the repeating initialization data pattern.

Method 650 may continue with snapshot application 170 reading the snapshot 300 of the segment 200 that is to be restored (block 660) and determining whether there is snapshot data associated with the entire storage segment 200 (block 662). For example, snapshot application 170 may determine that there is no snapshot data associated with portion 260 of storage segment. That is, that snapshot application 170 may determine that copy on write processes were not carried out for the modified initialization pattern data overwritten by the application data within portion 260 of segment 200.

Method 650 may continue with snapshot application 170 determining that there is snapshot data that is associated with the entire storage segment 200 and utilizing such snapshot data to restore the fully allocated storage segment (block 664). For example, snapshot application 170 may determine that there is no portion 260 of storage segment 200 after the point in time of snapshot 300 and that the portion 330 of snapshot 300 is associated with the portion 230 of segment 200 prior to the point in time of snapshot 300. Therefore, snapshot application 170 may reconstruct structure 200 utilizing portions 320, 330, and/or 350 of snapshot 300.

Method 650 may continue with snapshot application 170 determining that there are missing or nonexistent snapshot data associated with one or more portions of segment 200 and therefore utilizes the snapshot 300 to reconstruct storage segment 300 in addition to adding the repeated initialization data pattern to the one or more portions of segment 200 that which no snapshot data is associated (block 666). For example, snapshot application 170 may determine that there is no snapshot data associated with portion 260 of storage segment 200. That is, that snapshot application 170 may determine that copy on write processes were not carried out for the modified initialization pattern data that was overwritten by the application data within portion 260 of segment 200. Therefore, snapshot application 170 may reconstruct structure 200 utilizing portions 320, 330, and/or 350 of snapshot 300 in addition to adding the initialization pattern data to portion 260 of segment 200 that which no snapshot data was associated. Method 650 ends at block 566.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over those found in the marketplace, or to enable others of ordinary skill in the art to understand the embodiments disclosed herein.

What is claimed is:

1. A method of managing a snapshot of a fully allocated storage segment based upon data within the fully allocated storage segment, the method comprising:
allocating a storage segment consisting of a repeating initialization data pattern to a first application;
storing metadata associated with the storage segment that specifies the repeating initialization data pattern;
writing, with the first application, application data to a portion of the storage segment;
taking, with a snapshot application, a snapshot of the storage segment;
generating, with the first application, a post-snapshot-write to the storage segment;
determining, with the snapshot application, whether the post-snapshot-write modifies application data within the storage segment or modifies the repeating initialization data pattern within the storage segment;
if the post-snapshot-write modifies the repeating initialization data pattern within the storage segment, blocking, with the snapshot application, the repeating initialization data pattern from being copied and moved, thereby blocking modification of the snapshot of the storage segment; and
writing, with the first application, the post-snapshot-write to the storage segment thereby modifying the repeating initialization data pattern within the storage segment.

2. The method of claim 1, further comprising:
if the post-snapshot-write modifies application data within the storage segment, copy and moving, with the snapshot application, the application data to a destination storage location, thereby modifying the snapshot of the storage segment to identify the destination storage location of the moved application data.

3. The method of claim 2, further comprising:
writing, with the first application, the post-snapshot-write to the storage segment thereby modifying the application data within the storage segment.

4. The method of claim 2, wherein the destination storage location is not contained within the storage segment.

5. The method of claim 1, wherein determining whether the post-snapshot-write modifies application data within the storage segment or modifies the repeating initialization data pattern within the storage segment, comprises:
reading, with the snapshot application, the metadata associated with the storage segment that specifies the repeating initialization data pattern.

6. The method of claim 5, wherein determining whether the post-snapshot-write modifies application data within the storage segment or modifies the repeating initialization data pattern within the storage segment, further comprises:
identifying, with the snapshot application, preexisting data within the storage segment that is subsequently overwritten with the post-snapshot-write;
determining, with the snapshot application, whether the preexisting data equals the repeating initialization data pattern; and
if the preexisting data equals the repeating initialization data pattern, determining that the post-snapshot-write modifies the repeating initialization data pattern within the storage segment.

7. The method of claim 1, wherein the storage segment is a file.

8. A computer program product for managing a snapshot of a fully allocated storage segment based upon data within the fully allocated storage segment, the computer program product comprising a computer readable storage medium having program instructions embodied therewith, the program instructions are readable to cause a processor to:
allocate a storage segment consisting of a repeating initialization data pattern to a first application;
store metadata associated with the storage segment that specifies the repeating initialization data pattern;
write application data to a portion of the storage segment;
take a snapshot of the storage segment;
generate a post-snapshot-write to the storage segment;
determine whether the post-snapshot-write modifies application data within the storage segment or modifies the repeating initialization data pattern within the storage segment;
if the post-snapshot-write modifies the repeating initialization data pattern within the storage segment, block the repeating initialization data pattern from being copied and moved, and resultantly block modification of the snapshot of the storage segment; and
write the post-snapshot-write to the storage segment thereby modifying the repeating initialization data pattern within the storage segment.

9. The computer program product of claim 8, wherein the program instructions are readable to further the cause processor to:
if the post-snapshot-write modifies application data within the storage segment, copy and move the application data to a destination storage location, and resultantly modify the snapshot of the storage segment to identify the destination storage location of the moved application data.

10. The computer program product of claim 9, wherein the program instructions are readable to further the cause processor to:
write the post-snapshot-write to the storage segment thereby modifying the application data within the storage segment.

11. The computer program product of claim 9, wherein the destination storage location is not contained within the storage segment.

12. The computer program product of claim 8, wherein the program instructions that cause the processor to determine whether the post-snapshot-write modifies application data within the storage segment or modifies the repeating initialization data pattern within the storage segment, further the cause processor to:
read the metadata associated with the storage segment that specifies the repeating initialization data pattern.

13. The computer program product of claim 12, wherein the program instructions that cause the processor to determine whether the post-snapshot-write modifies application data within the storage segment or modifies the repeating initialization data pattern within the storage segment, further the cause processor to:
identify preexisting data within the storage segment that is subsequently overwritten with the post-snapshot-write;
determine whether the preexisting data equals the repeating initialization data pattern; and
if the preexisting data equals the repeating initialization data pattern, determine that the post-snapshot-write modifies the repeating initialization data pattern within the storage segment.

14. The computer program product of claim 1, wherein the storage segment is a file.

15. A computer comprising a processor and a memory having program instructions embodied therewith, the program instructions readable to cause the processor to:
allocate a storage segment consisting of a repeating initialization data pattern to a first application;
store metadata associated with the storage segment that specifies the repeating initialization data pattern;
write application data to a portion of the storage segment;
take a snapshot of the storage segment;
generate a post-snapshot-write to the storage segment;
determine whether the post-snapshot-write modifies application data within the storage segment or modifies the repeating initialization data pattern within the storage segment;
if the post-snapshot-write modifies the repeating initialization data pattern within the storage segment, block the repeating initialization data pattern from being copied and moved, and resultantly block modification of the snapshot of the storage segment; and
write the post-snapshot-write to the storage segment thereby modifying the repeating initialization data pattern within the storage segment.

16. The computer of claim 15, wherein the program instructions are readable to further the cause processor to:
if the post-snapshot-write modifies application data within the storage segment, copy and move the application data to a destination storage location, and resultantly modify the snapshot of the storage segment to identify the destination storage location of the moved application data.

17. The computer of claim 16, wherein the program instructions are readable to further the cause processor to:
write the post-snapshot-write to the storage segment thereby modifying the application data within the storage segment.

18. The computer of claim 16, wherein the destination storage location is not contained within the storage segment.

19. The computer of claim 15, wherein the program instructions that cause the processor to determine whether the post-snapshot-write modifies application data within the storage segment or modifies the repeating initialization data pattern within the storage segment, further the cause processor to:
read the metadata associated with the storage segment that specifies the repeating initialization data pattern.

20. The computer of claim 19, wherein the program instructions that cause the processor to determine whether the post-snapshot-write modifies application data within the storage segment or modifies the repeating initialization data pattern within the storage segment, further the cause processor to:
identify preexisting data within the storage segment that is subsequently overwritten with the post-snapshot-write;
determine whether the preexisting data equals the repeating initialization data pattern; and
if the preexisting data equals the repeating initialization data pattern, determine that the post-snapshot-write modifies the repeating initialization data pattern within the storage segment.
